(19) United States
(12) Patent Application Publication
(10) Pub. No.: US 2026/0145372 A1
(43) Pub. Date: May 28, 2026

(54) Manufacturing method for an insulated screwdriver head

(71) Applicant: E-MARK TOOLS INTERNATIONAL CO., LTD., Huatan Township (TW)

(72) Inventor: Kang-Yu Lee, Huatan Township (TW)

(21) Appl. No.: 19/390,763

(22) Filed: Nov. 17, 2025

(30) Foreign Application Priority Data
Nov. 22, 2024 (TW) 113145138

(51) Int. Cl. B29C 45/14; B25B 15/00; B29K 63/00; B29K 67/00; B29L 31/28

(52) U.S. Cl. CPC B29C 45/14426; B25B 15/002; B29C 45/14065; B29C 45/14639; B29K 2063/00; B29K 2067/006; B29L 2031/283

(57) ABSTRACT

A manufacturing method for an insulated screwdriver bit, the method comprising: material placing, mold closing, material injecting, mold opening, and sealing. The injecting process involves placing the screwdriver bit into a mold. The screwdriver bit is formed through metal processing and consists of a head section, a middle section, and a tail section. The outer diameter of the head section is larger than that of the middle and tail sections. The tail section has an end opening. The mold consists of an upper mold and a lower mold. The upper mold has a first mold cavity, and the lower mold has a second mold cavity. One end of the upper mold and the lower mold are respectively provided with a through hole, through which a positioning pin is inserted. The lower mold has a baffle wall, a plurality of feeding ports, a first ejector pin, and a second ejector pin.

### BACKGROUND OF THE INVENTION

### Field of Invention

The present invention relates to a manufacturing method for an insulated screwdriver bit.

### Description of the Related Art

Currently typical insulated screwdriver bits, such as those disclosed in FIG. 2 of German Patent Application No. DE102016212247A1, comprise a metal screwdriver bit 1 and an insulating layer 5. The metal screwdriver bit 1 has a body portion 3, a first end 6, and a second end 15. A recess 23 is formed on the second end 15, and the insulating layer 5 is coated onto the body portion 3 and the second end 15, allowing the first end 6 to be exposed. During the coating process, the insulating layer 5 fills up the recess 23 with a protrusion 25 to fully combine insulating layer 5 fills with the body portion 3 and the second end 15.

However, the conventional structure described above still has the following problems in practical applications: the insulating layer 5 can only be gripped at the first end 6 during coating because the protrusion 25 is integrally formed in the recess 23 along with the insulating layer 5, so the stability is not good. The insulating layer 5 is prone to significant differences in coating thickness due to slight shaking or tilting at the second end 15, resulting in a low yield rate in manufacturing.

Therefore, it is desirable to provide a manufacturing method for an insulated screwdriver bit to mitigate and/or obviate the aforementioned problems.

### SUMMARY OF THE INVENTION

An objective of present invention is to provide a manufacturing method for an insulated screwdriver bit, which is capable of improving the above-mention problems.

In order to achieve the above-mentioned objective, a manufacturing method for an insulated screwdriver bit, the method includes: material placing, mold closing, material injecting, mold opening, and sealing, to complete production of the insulating screwdriver bit; wherein:
the step of material placing is achieved by placing a screwdriver bit into a mold; the screwdriver bit is formed through metalworking, and comprises a head section, a middle section, and a tail section, and an outer diameter of the head section is larger than that of the middle and tail sections, and the tail section has an end opening; the mold comprises an upper mold and a lower mold, the upper mold has a first mold cavity, and the lower mold has a second mold cavity; a through-hole is formed and divided between one corresponding end of each of the upper and lower molds, and a positioning pin capable of entering or exiting from the first and second mold cavities is inserted in the through hole; another end of the lower mold has a baffle wall, and a bottom surface of the lower mold has a plurality of feeding ports for entering the second mold cavity and a first ejector pin and a second ejector pin are inserted; when the screwdriver bit is inserted into the second mold cavity of the lower mold, the first and second ejector pins respectively support the head and tail sections within the second mold cavity, ensuring the screwdriver bit remains horizontal and effectively separating the middle and tail sections from an inner wall of the second mold cavity;
the step of mold closing is achieved by the upper and lower molds moving closer together to align the first and second mold cavities to ensure that the middle and tail sections remain separated from the inner wall of the first mold cavity; the positioning pin is inserted into the end opening through the through-hole to secure the screwdriver bit between the baffle wall and the positioning pin, to ensure that even after the second ejector pin retracts, the screwdriver bit remains horizontally positioned, preventing wobbling or tilting;
the step of material injecting is achieved by injected a first insulating material into the first and second mold cavities through the feeding ports, completely covering the middle and tail sections within these cavities to form an insulating layer on the middle and tail sections;
the step of mold opening is achieved by separating the upper and lower molds, combined with the retraction of the positioning pins and the lifting of the first and second ejector pins, allows the screwdriver bit with the insulating layer to be removed from the mold; when the positioning pins retract, a working hole is formed in the insulating layer, and this working hole is directly connected to the port; and
the step of sealing is achieved by filling the end opening and the working hole with a second insulating material to form an insulating clog, thus sealing the end opening and the working hole; by simultaneously covering the metal middle and tail sections with the insulating layer and the insulating clog, the insulated screwdriver bit is formed.

### BRIEF DESCRIPTION OF THE DRAWINGS

FIG. 1 is a block flowchart of the present invention.

FIG. 2 is a perspective view of a screwdriver bit of a preferred embodiment according to the present invention.

FIG. 3 is a cross-sectional view of the screwdriver bit being placed inside the mold according to the present invention.

FIG. 4 is a cross-sectional view of the present invention after mold closing.

FIG. 5 is a state diagram during material injection according to the present invention.

FIG. 6 is a state diagram after mold opening and ejection according to the present invention.

FIG. 7 is a state diagram of forming the insulating clog during the step of material injecting according to the present invention.

FIG. 8 is a perspective view of forming the insulating screwdriver bit according to the present invention.

FIG. 9 is a cross-sectional view of the insulating screwdriver bit according to the present invention.

FIG. 10 is a state diagram of the insulating screwdriver bit being assembled to a tool via the tail section according to the present invention.

FIG. 11 is a state diagram of the insulating screwdriver bit being is attached to a tool according to the present invention.

### DETAILED DESCRIPTION OF PREFERRED EMBODIMENT

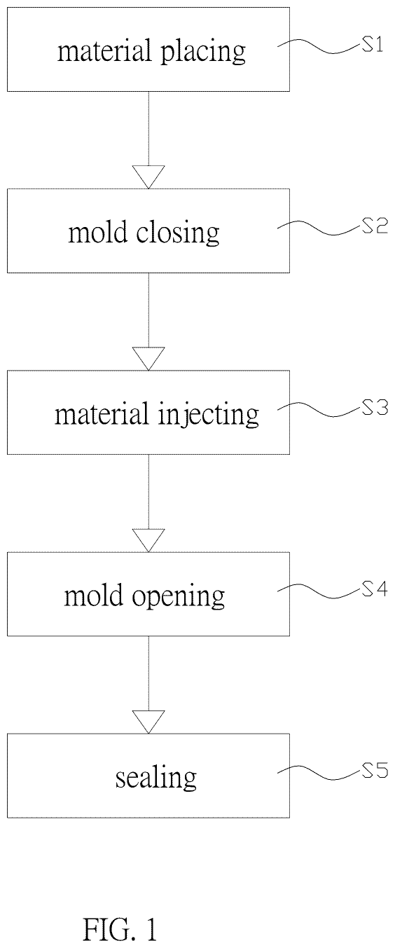

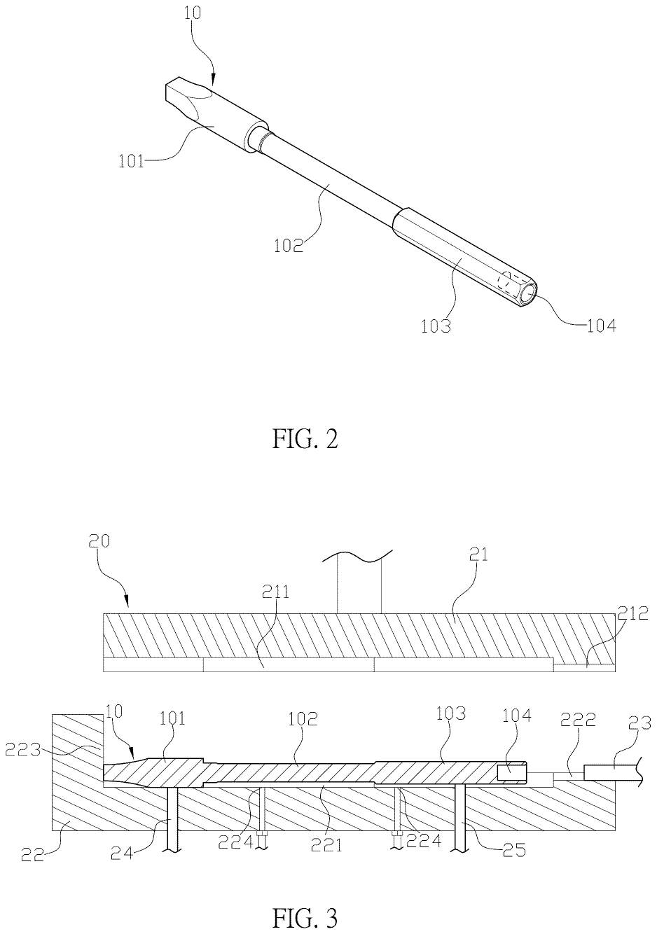

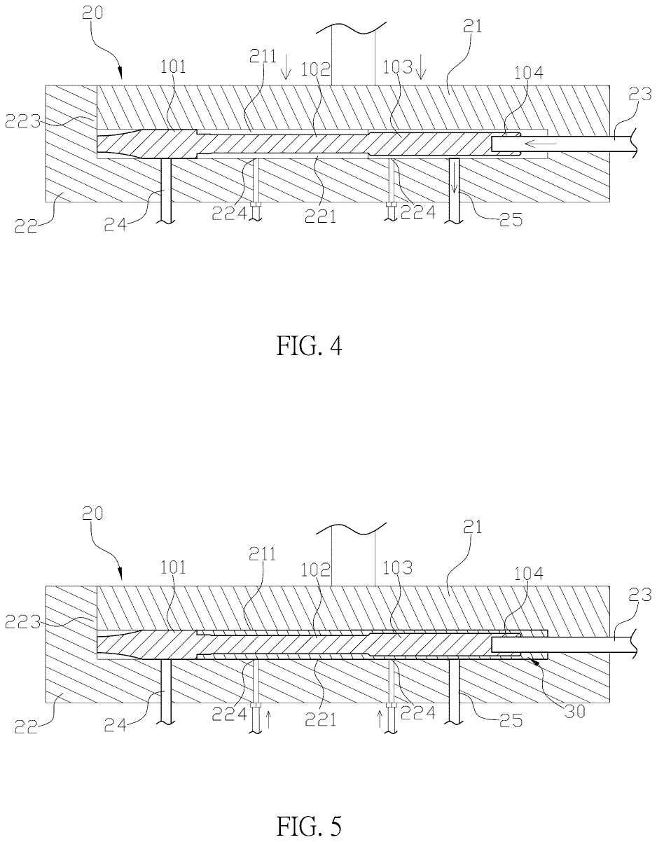

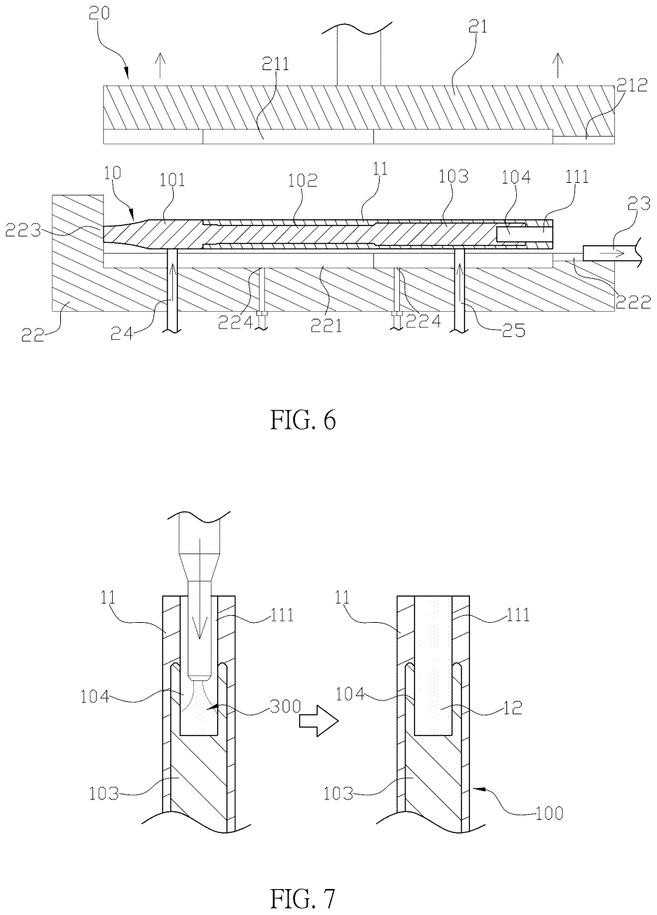

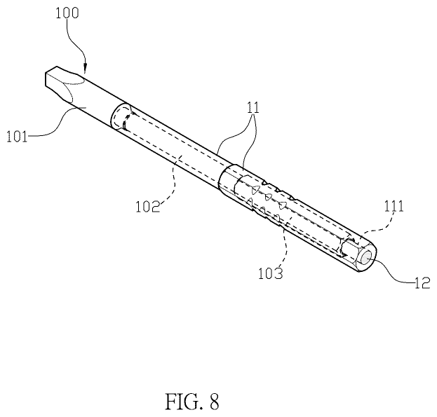

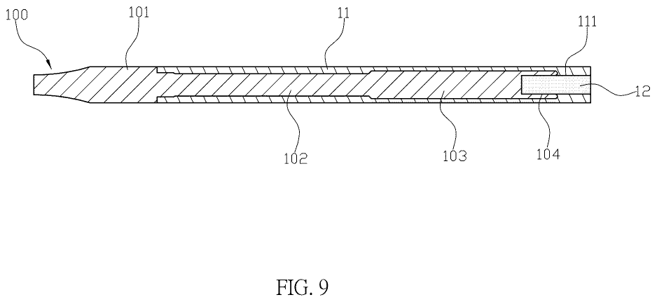

First, please refer to FIG. 1. A manufacturing method for an insulated screwdriver bit, the method comprises: material placing S1, mold closing S2, material injecting S3, mold opening S4, and sealing S5, to complete production of the insulating screwdriver bit 100. The step of material placing S1 is achieved by placing a screwdriver bit 10 into a mold 20. The screwdriver bit 10 is formed through metalworking, and comprises a head section 101, a middle section 102, and a tail section 103, an outer diameter of the head section 101 is larger than that of the middle and tail sections 102, 103, and the tail section 103 has an end opening 104, as shown in FIG. 2. The mold 20 comprises an upper mold 21 and a lower mold 22, the upper mold 21 has a first mold cavity 211, and the lower mold 22 has a second mold cavity 221. A through-hole 212, 222 is formed and divided between one corresponding end of each of the upper and lower molds 21, 22, and a positioning pin 23 capable of entering or exiting from the first and second mold cavities 211, 221 is inserted in the through hole 212. Another end of the lower mold 22 has a baffle wall 223, and a bottom surface of the lower mold 22 has a plurality of feeding ports 224 for entering the second mold cavity 221 and a first ejector pin 24 and a second ejector pin 25 are inserted. When the screwdriver bit 10 is inserted into the second mold cavity 221 of the lower mold 22, the first and second ejector pins 24, 25 respectively support the head and tail sections 101, 103 within the second mold cavity 221, ensuring the screwdriver bit 10 remains horizontal and effectively separating the middle and tail sections 102, 103 from an inner wall of the second mold cavity 221, as shown in FIG. 3. The step of mold closing S2 is achieved by the upper and lower molds 21, 22 moving closer together to align the first and second mold cavities 211, 221 to ensure that the middle and tail sections 102, 103 remain separated from the inner wall of the first mold cavity 211. The positioning pin 23 is inserted into the end opening 104 through the through holes 212, 222 to secure the screwdriver bit 10 between the baffle wall 223 and the positioning pin 23, to ensure that even after the second ejector pin 25 retracts, the screwdriver bit 10 remains horizontally positioned (as shown in FIG. 4), preventing wobbling or tilting. The step of material injecting S3 is achieved by injected a first insulating material 30 into the first and second mold cavities 211, 221 through the feeding ports 224, completely covering the middle and tail sections 102,103 within these cavities to form an insulating layer 11 on the middle and tail sections 102,103, as shown in FIG. 5. The step of mold opening S4 is achieved by separating the upper and lower molds 21, 22, combined with the retraction of the positioning pins 23 and the lifting of the first and second ejector pins 24, 25, allows the screwdriver bit 10 with the insulating layer 11 to be removed from the mold 20. When the positioning pins 23 retract, a working hole 111 is formed in the insulating layer 11, and this working hole 111 is directly connected to the end opening 104, as shown in FIG. 6. The step of sealing S5 is achieved by filling the end opening 104 and the working hole 111 with a second insulating material 300 to form an insulating clog 12, thus sealing the end opening 104 and the working hole 111, as shown in FIG. 7. By simultaneously covering the metal middle and tail sections 102, 103 with the insulating layer 11 and the insulating clog 12, as shown in FIGS. 8 and 9, the insulated screwdriver bit 100 is formed.

Furthermore, the head section 101 can be square, straight, cross-shaped, or other different shape, to allow the insulated screwdriver bit 100 to use the head section 101 to engage and rotate the connected components, such as screws and bolts, to change their position.

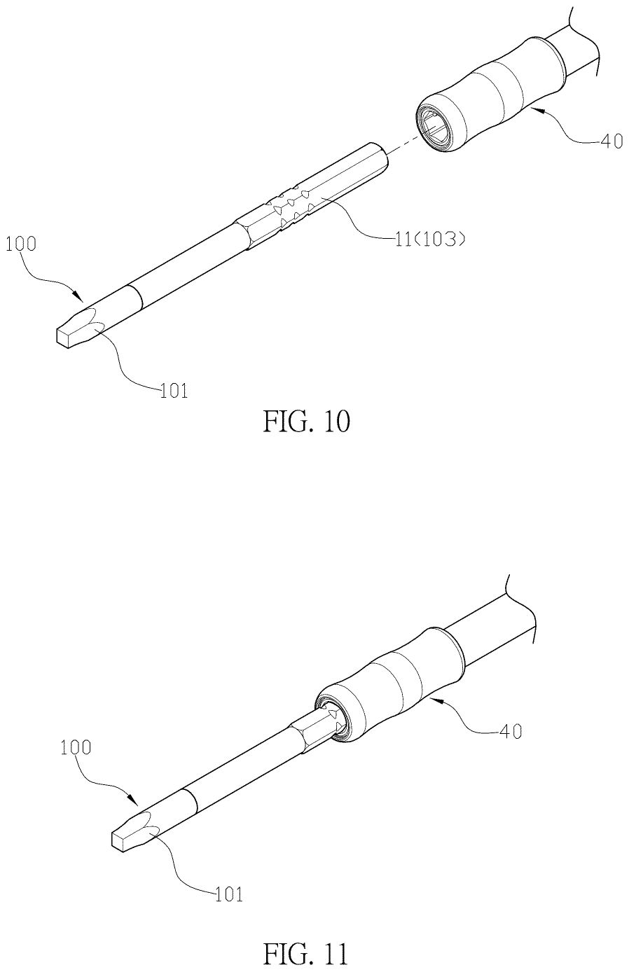

Moreover, the tail section 103 is a hexagonal driving part, as shown in FIGS. 10 and 11, and the tail section 103 provides tools 40 such as socket screwdrivers for assembly.

In addition, the first insulating material 30 is polybutylene terephthalate (PBT).

Also, the second insulating material 300 is epoxy resin.

The manufacturing method for an insulated screwdriver bit described above has the following advantages: After the mold 20 is closed together, the positioning pin 23 pushes the screwdriver bit 10 to press against the baffle wall 223, so that the head section 101 and the tail section 103 can be fully fixed at the same time. By fixing both ends at the same time, the screwdriver bit 10 can be prevented from shaking or tilting during the injection process S3, and the insulating layer 11 can be evenly covered on the middle section 102 and the tail section 103, resulting in a high product yield.

Although the present invention has been explained in relation to its preferred embodiment, it is to be understood that many other possible modifications and variations can be made without departing from the spirit and scope of invention as hereinafter claimed.

What is claimed is:

1. A manufacturing method for an insulated screwdriver bit, the method comprising: material placing, mold closing, material injecting, mold opening, and sealing, to complete production of the insulating screwdriver bit; wherein:
the step of material placing is achieved by placing a screwdriver bit into a mold; the screwdriver bit is formed through metalworking, and comprises a head section, a middle section, and a tail section, and an outer diameter of the head section is larger than that of the middle and tail sections, and the tail section has an end opening; the mold comprises an upper mold and a lower mold, the upper mold has a first mold cavity, and the lower mold has a second mold cavity; a through-hole is formed and divided between one corresponding end of each of the upper and lower molds, and a positioning pin capable of entering or exiting from the first and second mold cavities is inserted in the through hole; another end of the lower mold has a baffle wall, and a bottom surface of the lower mold has a plurality of feeding ports for entering the second mold cavity and a first ejector pin and a second ejector pin are inserted; when the screwdriver bit is inserted into the second mold cavity of the lower mold, the first and second ejector pins respectively support the head and tail sections within the second mold cavity, ensuring the screwdriver bit remains horizontal and effectively separating the middle and tail sections from an inner wall of the second mold cavity;
the step of mold closing is achieved by the upper and lower molds moving closer together to align the first and second mold cavities to ensure that the middle and tail sections remain separated from the inner wall of the first mold cavity; the positioning pin is inserted into the end opening through the through-hole to secure the screwdriver bit between the baffle wall and the positioning pin, to ensure that even after the second ejector pin retracts, the screwdriver bit remains horizontally positioned, preventing wobbling or tilting;
the step of material injecting is achieved by injected a first insulating material into the first and second mold cavities through the feeding ports, completely covering the middle and tail sections within these cavities to form an insulating layer on the middle and tail sections;
the step of mold opening is achieved by separating the upper and lower molds, combined with the retraction of the positioning pins and the lifting of the first and second ejector pins, allows the screwdriver bit with the insulating layer to be removed from the mold; when the positioning pins retract, a working hole is formed in the insulating layer, and this working hole is directly connected to the port; and
the step of sealing is achieved by filling the end opening and the working hole with a second insulating material to form an insulating clog, thus sealing the end opening and the working hole; by simultaneously covering the metal middle and tail sections with the insulating layer and the insulating clog, the insulated screwdriver bit is formed.

2. The manufacturing method for an insulated screwdriver bit as claimed in claim 1, wherein the head section can be square, straight, cross-shaped, or other different shapes.

3. The manufacturing method for an insulated screwdriver bit as claimed in claim 1, wherein the tail section is a hexagonal driving part.

4. The manufacturing method for an insulated screwdriver bit as claimed in claim 1, wherein the first insulating material is polybutylene terephthalate.

5. The manufacturing method for an insulated screwdriver bit as claimed in claim 1, wherein the second insulating material is epoxy resin.
